(19) United States
(12) Patent Application Publication
(10) Pub. No.: US 2026/0320048 A1
(43) Pub. Date: Oct. 15, 2026

(54) MODEL PERFORMANCE-GUIDED EVALUATION DATA SELECTION FOR EFFECTIVE PROMPT OPTIMIZATON

(71) Applicant: HUAWEI TECHNOLOGIES CO., LTD., Shenzhen (CN)

(72) Inventors: Shaowei Wang, Winnipeg (CA); Ximing Dong, Kingston (CA); Dayi Lin, Toronto (CA); Ahmed E. Hassan, Kingston (CA)

(73) Assignee: HUAWEI TECHNOLOGIES CO., LTD., Shenzhen (CN)

(21) Appl. No.: 19/261,308

(22) Filed: Jul. 7, 2025

Related U.S. Application Data
(60) Provisional application No. 63/788,980, filed on Apr. 15, 2025.

(51) Int. Cl. G06F 16/2453; G06F 18/23

(52) U.S. Cl. CPC G06F 16/24542; G06F 18/23

(57) ABSTRACT

There is provided a method for selecting an evaluation dataset for prompt optimization from a training dataset. The method involves selecting representative samples from the training dataset using semantic clustering, and selecting boundary samples from the training dataset. The method further involves using an LLM and evaluating the LLM's performance to refine the evaluation dataset. Samples which produce redundant results on the LLM are replaced by other samples which are likely to produce different results.

### CROSS-REFERENCE TO RELATED APPLICATIONS

The present application claims priority from U.S. Patent Application No. 63/788,980, filed on Apr. 15, 2025.

### FIELD OF THE DISCLOSURE

The present disclosure relates to Artificial Intelligence (AI) Large Language Models (LLMs). In particular, the present disclosure relates to a method of evaluation data selection for prompt optimization.

### BACKGROUND

Optimizing Large Language Model (LLM) performance requires well-crafted prompts, but manual prompt engineering is labor-intensive and often ineffective. Automated prompt optimization techniques address this challenge but the majority of them rely on randomly selected evaluation subsets, which fail to represent the full dataset, leading to unreliable evaluations and suboptimal prompts. Existing coreset selection methods, designed for LLM benchmarking, are unsuitable for prompt optimization due to challenges in clustering similar samples, high data collection costs, and the unavailability of performance data for new or private datasets. Therefore, there is a need to optimize the selection of an evaluation dataset for prompt optimization.

### SUMMARY

It is an object of the present disclosure to provide an improved method for selecting data for prompt optimization. In some aspects, this disclosure relates to an iterative evaluation data selection for effective prompt optimization using real-time model performance. Evaluation data may dynamically evolve based on model performance in real-time. This process may leverage real-time model performance observed during prompt optimization, eliminating the need for pre-collected performance data from existing models or preliminary evaluations. This real-time model performance-guided iterative refinement may serve as a versatile plugin alongside any data sampling approach to refine evaluation data during runtime.

According to a first aspect, there is provided a method at a computing device for selecting an evaluation dataset from a training dataset, comprising: a) embedding samples from the training dataset into a semantic space b) clustering the embedded samples into a plurality of clusters c) adding a portion of each cluster to the evaluation dataset d) finding boundary samples from the embedded samples e) adding the boundary samples to the evaluation dataset f) running a Large Language Model (LLM) on each sample of the evaluation dataset using a set of prompts g) recording a performance matrix, the performance matrix comprising a vector for each sample of the evaluation dataset, wherein the vector for a given sample represents outputs of the LLM for the given sample across each prompt of the set of prompts h) identifying, based on the performance matrix, redundant samples from the evaluation dataset, and i) replacing at least a portion of the redundant samples with new samples from the training dataset.

According to an embodiment of the first aspect, the set of prompts is generated by a prompt optimization technique.

According to another embodiment of the first aspect, the method further comprises repeating steps f), g), h), and i) with a new set of prompts from the prompt optimization technique.

According to yet another embodiment of the first aspect, the method further comprises removing, from the training dataset, samples added to the evaluation dataset.

According to yet another embodiment of the first aspect the method further comprises receiving an input indicating a size N of the evaluation dataset; wherein step c) adds αN samples to the evaluation dataset, where α is a proportion of samples to be obtained from semantic clustering.

According to yet another embodiment of the first aspect, step e) adds (1−α)N boundary samples to the evaluation dataset.

According to yet another embodiment of the first aspect, step c) adds a number of samples from each cluster which is proportional to a size of each cluster.

According to yet another embodiment of the first aspect, step d) comprises finding a first set of boundary samples in the semantic space.

According to yet another embodiment of the first aspect, the method further comprises for each boundary sample in the first set of boundary samples, a most distant sample in the semantic space.

According to yet another embodiment of the first aspect the outputs for of the LLM for the given sample is a vector of logit values.

According to yet another embodiment of the first aspect, two samples are considered redundant if their respective vectors from the performance matrix have a correlation coefficient greater than a threshold.

According to yet another embodiment of the first aspect, the threshold is 0.9.

According to yet another embodiment of the first aspect, step h) comprises creating clusters of redundant samples.

According to yet another embodiment of the first aspect, step i) comprises removing a portion β of each cluster of redundant samples.

According to yet another embodiment of the first aspect step i) comprises replacing removed samples, wherein a replacement sample for a given removed sample is a most distant sample of the given removed sample in the training dataset.

According to yet another embodiment of the first aspect, the most distant sample is identified using a Hierarchical Navigable Small World (HNSW) algorithm.

According to a second aspect, there is provided a computing device comprising a processor and memory, wherein the computing device is configured to perform the method of any embodiment of the first aspect.

According to a third aspect, there is provided a computer readable medium having stored thereon executable code for execution by a computing device, the executable code comprising instructions for performing the method of any embodiment of the first aspect. In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

### BRIEF DESCRIPTION OF THE DRAWINGS

FIG. 1 is a diagram illustrating a method according to at least some embodiments of the present disclosure.

FIG. 2 is a flow diagram illustrating a method for the first stage according to at least some embodiments of the present disclosure.

FIG. 3 is a heat map of the correlation of model output between different samples.

FIG. 4 is a flow diagram illustrating a method for the second stage according to at least some embodiments of the present disclosure.

FIG. 5 is a block diagram of computing device according to at least one embodiment of the present disclosure.

FIG. 6 is a schematic diagram showing an Artificial Intelligence (AI) engine, wherein the AI engine comprises a Large Language Model (LLM).

FIG. 7A is a schematic diagram showing an encoder-based LLM.

FIG. 7B is a schematic diagram showing a decoder-based LLM.

FIG. 7C is a schematic diagram showing an encoder-decoder-based LLM.

### DETAILED DESCRIPTION

The present disclosure to provides an improved method for selecting data for prompt optimization.

Throughout the present disclosure, the following terminology will be used.

Natural Language Processing (NLP): a field of artificial intelligence that focuses on the interaction between computers and humans through natural language. The ultimate objective of NLP is to read, decipher, understand, and make sense of human languages in a manner that is valuable.

Optimizing Large Language Model (LLM) performance: involves several strategies and techniques aimed at improving efficiency, accuracy, and applicability of these models in various NLP tasks.

Prompt: a type of input given to a language model that initiates or guides its generation of text or responses.

Prompt optimization techniques: methods used to improve the effectiveness of prompts in guiding language models to generate desired outputs.

Evaluation subsets or evaluation dataset: in the context of machine learning and natural language processing (NLP), evaluation subsets refer to data used to test and evaluate the performance of a model.

Coreset selection methods: algorithms and techniques used in data analysis and machine learning to create a representative subset (called a “coreset”) of a larger dataset.

LLM benchmarking: evaluating the performance of LLMs across a range of tasks and metrics to determine their capabilities, strengths, and weaknesses.

Semantics-based approaches: focus on understanding and generating the meaning of text, rather than just analyzing its structure or syntax.

Semantic representations: structured forms that capture the meaning of words, phrases, sentences, or even larger text units in a way that computers can process. These representations are fundamental for various NLP tasks that require a deep understanding of language, such as machine translation, summarization, and information retrieval.

Model-generated outputs: the results produced by a computational model in response to specific inputs.

Ground-truth: the accurate, objective facts or data that are used as a benchmark to evaluate the correctness of a model's predictions or outputs.

Generalization performance: refers to the ability of a machine learning model to perform well on new, previously unseen data, beyond the examples included in the training set.

Task performance: refers to how effectively a model completes a specific task it's designed for, using metrics that quantify its accuracy, efficiency, and overall effectiveness.

Semantic and model performance: “semantic performance” typically pertains to how well a model comprehends and processes the meaning of text, and its ability to grasp and manipulate linguistic concepts accurately. “Model performance” generally refers to the broader capabilities of the model across various metrics and tasks, which may include but are not limited to semantic understanding.

Cluster samples: clustering samples in the context of machine learning and data science refers to the process of grouping a set of objects (or data points) in such a way that objects in the same group (called a cluster) are more similar to each other than to those in other groups.

Boundary cases: also known as edge cases, are conditions or situations that occur at the extreme ends of operating parameters. In the context of software development, data science, and machine learning, these cases represent unusual, unexpected, or rare conditions that challenge the system's ability to function properly.

Semantic clustering: is a technique used in natural language processing (NLP) and information retrieval that involves grouping text documents, sentences, or phrases based on their underlying semantic similarity rather than their superficial syntactic structure.

Boundary selection: refers to methods used to define or identify the edges or limits of objects, data structures, or conceptual entities. The specific approach can vary significantly depending on the domain and the nature of the data being analyzed.

The input to a Large Language Model (LLM) is often called a ‘prompt’. It provides instructions to the LLM, and the LLM uses the prompt as input in order to create the output, which is a response to the prompt. The prompt is generally a natural language phrase, which is intended to elicit a response from the LLM. A properly worded prompt may elicit a better-quality response from the LLM.

Prompt optimization relates to techniques for creating prompts which elicit a more accurate and relevant response from the LLM. Such prompt optimization techniques may allow a user to obtain superior performance from a given LLM.

There are currently no known evaluation data selection techniques, or evaluation data sets, optimized for prompt optimization. The most relevant domain is coreset selection for machine learning models. Coreset selection relates to the selection of a small and representative subset of a larger dataset.

Numerous approaches have been developed for coreset selection in recent years. These approaches can generally be classified into three main families.

Geometry-based methods assume that semantically similar data points share properties, as exemplified by Chen et al., “Super-samples from kernel herding”, March 2012, arXiv:1203.3472, by Sener et al., “Active Learning for Convolutional Neural Networks: A Core-Set Approach”, August 2017, arXiv:1708.00489, by Sinha et al., “Small-GAN: Speeding Up GAN Training Using Core-sets”, October 2019, arXiv:1910.13540, and by Agarwal et al., “Contextual Diversity for Active Learning”, August 2020, arXiv:2008.05723.

However, solely relying on semantics while overlooking the model performance could lead to sub-optimal performance in identifying representative samples, typically for tasks where the samples are naturally semantically close to each other. In performance-based approaches, other factors may be considered, such as confidence, as exemplified by Coleman et al., “Selection via Proxy: Efficient Data Selection for Deep Learning”, June 2019, arXiv:1906.11829, by Margatina et al., “Active Learning by Acquiring Contrastive Examples”, September 2021, arXiv:2109.03764, by Lin et al., “Optimal Sample Selection Through Uncertainty Estimation and Its Application in Deep Learning”, September 2023, arXiv:2309.02476, and by Kim et al., “Confident Coreset for Active Learning in Medical Image Analysis”, April 2020, arXiv:2004.02200. Others focus on error, as exemplified by Paul et al., “Deep Learning on a Data Diet: Finding Important Examples Early in Training”, July 2021, arXiv:2107.07075, by Toneva et al., “An Empirical Study of Example Forgetting during Deep Neural Network Learning”, December 2018, arXiv:1812.05159, and by Liu et al., “Just Train Twice: Improving Group Robustness without Training Group Information”, July 2021, arXiv:2107.09044. Approaches based on confidence prioritize uncertain samples, assuming they have a greater impact on model performance.

Decision boundary-based approaches focus on samples near the decision boundary, since they are harder to classify and valuable for coreset selection. More recently, methods have leveraged evaluation results from previously tested LLMs to predict the performance of new models, for example in Pacchiardi et al., “100 instances is all you need: predicting the success of a new LLM on unseen data by testing on a few instances”, September 2024, arXiv:2409.03563, and in Vivek et al., “Anchor Points: Benchmarking Models with Much Fewer Examples”, September 2023, arXiv:2309.08638.

Existing prompt techniques either randomly select a subset from an entire training set or use the entire training data for evaluation. Random selection often fails to produce representative samples of the entire training dataset, leading to unreliable evaluation results and under-optimized prompts. Using the entire training data is time and resource intensive.

Existing coreset selection approaches are not well-suited for prompt optimization. In semantics-based approaches, samples for certain tasks (e.g., Navigation task from BIG-bench) tend to be highly similar, making it challenging to cluster them effectively solely based on their semantics. On the other hand, approaches that leverage model performance information rely on evaluation results from previously tested models to predict the performance of new models. However, such approaches have notable limitations. Firstly, model performance data and training samples are not always available, particularly for new or proprietary datasets. Even when it is possible, collecting the model performance information prior to the prompt optimization process is expensive. Secondly, using past model performance to estimate the capabilities of current LLMs often results in sub-optimal predictions, as model behaviors may vary significantly.

According to the present disclosure, given an LLM L and a task T, and an evaluation dataset

$${D}^{evaluation} = {\{ {x}_{i} , {y}_{i} \}}_{i = 1}^{N} ,$$

where xᵢ are inputs and yᵢ are the corresponding desired outputs fo T. A prompt P is a sequence of tokens that guides L to generate outputs ŷⱼ=L(xⱼ,P).

The objective of prompt optimization is to find a prompt P* that maximizes the task performance over D^{evaluation}. This can be expressed as:

$${P}^{*} = arg {max}_{P} M ( {\{ L ( {x}_{i} , P ) , {y}_{i} \}}_{i = 1}^{N} )$$

where M is a performance metric that quantifies the alignment between the model-generated outputs ŷᵢ=L(xᵢ,P) and the ground-truth outputs yᵢ, such as Accuracy, F1-score, BLEU score, or task-specific measures.

There is currently no known prior art technique for evaluation data selection in the context of prompt optimization. The goal of evaluation selection is to find the most informative subset D^{evaluation}⊂D^{training}, with the constraint that |D^{evaluation}|<<|D^{training}|, so that prompts optimized on D^{evaluation} have a performance similar to that of the prompts optimized on D^{training}.

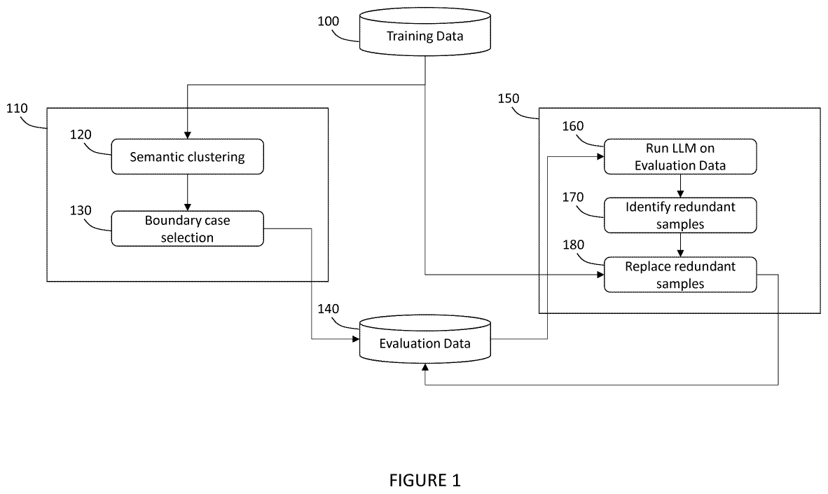

The present disclosure proposes a two-stage approach that leverages both semantic and model performance features to select evaluation data for effective prompt optimization, as illustrated in FIG. 1.

Specifically, as seen in FIG. 1, a method for selecting an evaluation dataset 140 for prompt optimization from a training dataset 100 is illustrated. The method comprises a first stage 110 and a second stage 150.

In the first stage 110, a diverse sample is selected from the training dataset 100, and in second stage 150, redundant samples are removed and replaced with distinct samples.

First stage 110 comprises step 120, in which semantic clustering is used to identify samples from the training dataset with similar meaning. Samples are then selected from each cluster, and added to the evaluation dataset 140.

First stage 110 further comprises step 130, in which boundary cases are identified. The boundary cases are then added to the evaluation dataset 140.

Therefore, after the first stage 110, the evaluation dataset 140 comprises samples from each semantic cluster, as well as boundary cases.

In the second stage 150, redundant samples are removed from the evaluation dataset 140 and replaced with different samples from training dataset 100.

Second stage 150 comprises step 160, in which the LLM is run on samples from the evaluation dataset 140. Each sample may be fed to the LLM multiple times using different prompts. The LLM's output for each sample across the different prompts is then used to identify redundant samples, at step 170. A sample may be considered redundant if the LLM's output across different prompts produce similar results to another sample.

Once redundant samples are identified, the method proceeds to step 180 where redundant samples are removed from evaluation dataset 140 and replaced by dissimilar samples from training dataset 100.

Each stage is described in greater detail below.

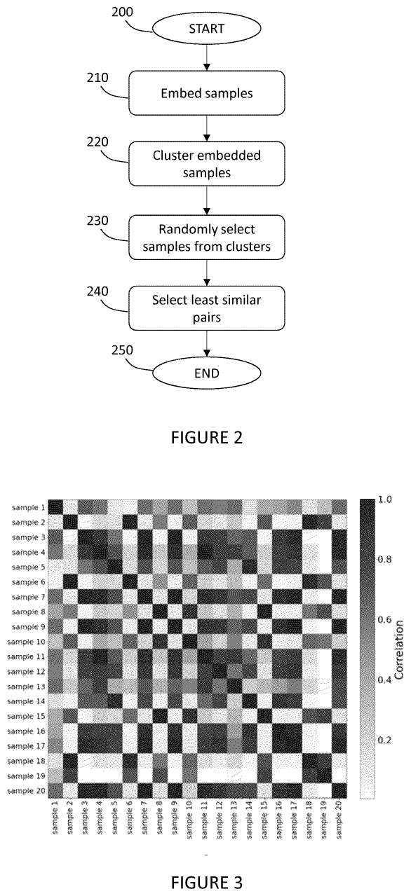

Reference is now made to FIG. 2 in which a method for the first stage is illustrated. The method of FIG. 2 may have as inputs, a training dataset D^{training}, a number of samples to select N, a number of clustering groups k, and a portion of samples to be selected from semantic clustering a.

The method starts at block 200 and proceeds to block 210, in which the samples from the dataset are embedded into a semantic latent space. Specifically, the samples from the dataset are converted into a vector representation, in which semantically similar phrases are close to each other, and in which semantically different phrases are far apart from each other. In at least some embodiments, the samples may be embedded using Sentence-BERT.

Once the samples are embedded, the method proceeds to block 220 where the samples are clustered into k clusters. The value of k may be user defined, or in some cases a default value may be used. Specifically, while the semantic latent space into which the samples are embedded is a d-dimensional space, where d is typically greater than 100, each sample may be visualized as a point in space, and points that are closer together within that space may be clustered. Various tools may be used to perform the clustering. For example, in at least some embodiments, K-means may be used for clustering.

The method then proceeds to block 230 where samples are randomly selected from each cluster. Assuming that D^{training} comprises M samples, the number of samples to select from D^{training} is N, and the portion of samples to be selected from semantic clustering is α, αN is the number of samples to be randomly selected from all the clusters. In at least some embodiments, the number of samples selected from a given cluster is proportional to the size of the given cluster, and may be expressed as

$${c}_{select} = \frac{{c}_{size} α N}{M} ,$$

Where C_{select} is the number of samples to select from cluster C, and C_{size} is the size of cluster C. The selected samples are then added to the evaluation dataset, and removed from the training dataset.

It has been found that only using clustering can result in omitting boundary cases, which can be useful in prompt optimization. Accordingly, the method further comprises adding boundary cases to the evaluation dataset.

Following Huang et al., “Semantic-guided Prompt Organization for Universal Goal Hijacking against LLMs”, May 2024, arXiv:2405.14189, boundary cases may be identified by identifying samples which are furthest away from each other in the embedding space. The method therefore proceeds to block 240 where least similar pairs from the training dataset are identified. In order to reduce the amount of computation necessary, the samples which were added to the evaluation dataset at block 230 do not need to be considered.

Calculating the distance among all samples is computationally expensive, with a time complexity of O(dM²), where d is the dimension of embeddings and M is the size of dataset. To improve efficiency, in some embodiments, a first set of boundary points is first detected in the latent space by following Angiulli et al., “Fast Outlier Detection in High Dimensional Spaces”, January 2002. While this technique may identify some boundary points, additional boundary points may be required. Additional boundary points may be determined by finding a most distant sample from each of the boundary points in the first set.

(1−α)N boundary samples may be added to the evaluation data set at block 240, in order to produce N samples in total. These boundary samples may also be removed from the training data set.

The method then ends at block 250.

After stage 1, a reduced set D^{evaluation} is obtained, based on semantic clustering and semantic boundaries. However, solely relying on semantics while overlooking model performance could lead to sub-optimal results, particularly for tasks where the samples are naturally semantically close to each other. To address this, the present disclosure further provides a method which further modifies the dataset based on how a specific LLM performs in response to different samples. Specifically, the method replaces redundant samples with contrasting ones based on their model performance This method leverages real-time model performance observed during prompt optimization, eliminating the need for pre-collected performance data from existing models or preliminary evaluations.

This approach is based on the observation that a significant portion of samples exhibit high correlations in their model performance across prompts during prompt optimization. FIG. 3 presents a heatmap where each cell represents the correlation between two samples based on their real-time model performance. How the correlation between two samples is obtained is described below. As can be observed from FIG. 3, a substantial portion of samples (20% in this case) exhibits a correlation greater than 0.9 with others. This indicates redundancy among these samples, and suggests that they can be replaced with alternative samples from the training set to enhance the diversity of D^{evaluation}.

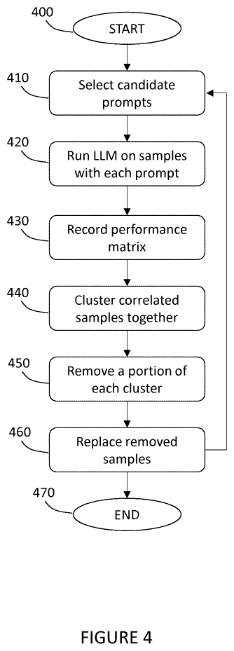

Reference is now made to FIG. 4, which illustrates a method for the second stage according to at least some embodiments of the present disclosure. The method of FIG. 4 may be performed iteratively, where given a prompt optimization technique PO, for each iteration, the redundant samples in D^{evaluation} are identified, and a portion of them are replaced with a dissimilar sample retrieved from the training dataset D^{training}.

The method starts at block 400 and proceeds to block 410 where candidate prompts are selected. For example, prompts may be generated using a prompt optimization technique PO.

The method then proceeds to block 420 where each sample is fed through the LLM L, using each of the prompts selected at block 410. The performance of L is then registered in the performance matrix MPᵣᵤₙₜᵢₘₑ at block 430. The performance matrix is composed of real numbers, which correspond to logits, as the proxy of the model's confidence. The performance matrix has dimensions |D^{evaluation}|×(|output|×|prompts|).

Specifically, the performance matrix may comprise a row for each sample in D^{evaluation}, and each row may contain a vector of the model's output for each prompt in the set of candidate prompts, prompts.

As an example, if the output labels of a task on model L are True, False, and Other, the output may be represented as a three dimensional vector V={logit(True), logit(False), logit(Other)}, where logits are the output values from the last layer of a neural network that have not yet been normalized into probabilities. Each row of the performance matrix may then comprise one such vector for each prompt of the set of candidate prompts.

The method then proceeds to block 440, where highly correlated samples are clustered together, based on the performance matrix. According to at least some embodiments, two samples are considered to be highly correlated if their corresponding vector in the performance matrix have a correlation coefficient above a threshold. In at least some embodiments, this threshold is 0.9.

In at least some embodiments, a hierarchical cluster is used to build clusters and group samples that share high correlations in the same cluster, based on Wang et al., “Understanding the factors for fast answers in technical Q&A websites: an empirical study of four stack exchange websites”, ICSE '18: Proceedings of the 40th International Conference on Software Engineering, p. 884, May 2018, and on Rajbahadur et al., “The Impact of Using Regression Models to Build Defect Classifiers”, February 2022, arXiv:2202.06157.

The method then proceeds to block 450 where a portion β of each cluster with highly correlated samples are removed. The value of β may be a parameter set by the user, or a constant.

The method then proceeds to block 460, where the removed samples are replaced by samples from the training dataset D^{training}. According to at least some embodiments, the replacement for a given sample is selected by searching the training dataset D^{training} for the most distant sample from the given sample in the semantic latent space, based on the notion that the pair of samples with the lowest semantic similarity is the most likely to produce different model performances. According to at least some embodiments, the search is performed using Hierarchical Navigable Small World (HNSW), due to its efficiency in high-dimensional spaces, by inverting the similarity function to calculate the dissimilarity between two samples.

In at least some embodiments, the method may then repeat itself and proceed back to block 410, with a new set of prompts from a prompt optimization technique PO. Alternatively, the method ends at block 470.

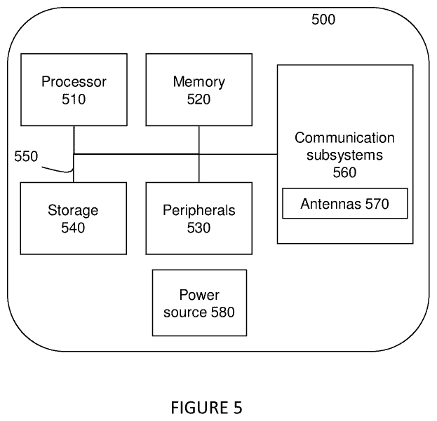

The above functionality may be implemented on any one or combination of computing devices. FIG. 5 is a block diagram of a computing device 500 that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The computing device 500 may comprise a processor 510, memory 520, a mass storage device 540, and peripherals 530. Peripherals 530 may comprise, amongst others one or more input/output devices, such as a speaker, microphone, mouse, touchscreen, keypad, keyboard, printer, display, network interfaces, and the like. Communications between processor 510, memory 520, mass storage device 540, and peripherals 530 may occur through one or more buses 550.

The bus 550 may be one or more of any type of several bus architectures including a memory bus or memory controller, a peripheral bus, video bus, or the like. The processor 510 may comprise any type of electronic data processor. The memory 520 may comprise any type of system memory such as static random-access memory (SRAM), dynamic random-access memory (DRAM), synchronous DRAM (SDRAM), read-only memory (ROM), a combination thereof, or the like. In an embodiment, the memory 520 may include ROM for use at boot-up, and DRAM for program and data storage for use while executing programs.

The mass storage device 540 may comprise any type of storage device configured to store data, programs (e.g. instructions or code), and other information and to make the data, programs, and other information accessible via the bus. The mass storage device 540 may comprise, for example, one or more of a solid-state drive, hard disk drive, a magnetic disk drive, an optical disk drive, or the like. The memory 520 or mass storage 540 may store instructions, which when executed by a processor or processing unit, cause or configure the computing device 500 to perform any of the methods described herein.

Computing device 500 may further comprise a communications subsystem 560 for communicating with other computing devices or for connecting computing device 500 to a computer network. Communications subsystem 560 may comprise one or more network interfaces (not shown), which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas 570 and one or more receivers/receive antennas 570. In an embodiment, the processing unit is coupled to a local-area network or a wide-area network, for data processing and communications with remote devices, such as other processing units, the Internet, remote storage facilities, or the like.

Computing device may further comprise a power source 580.

The present disclosure may be implemented on a computing device such as exemplary computing device 500. Computing device 500 may be a network element of a telecommunications network, such that the network element may be connected to other network elements of the telecommunication network, where all network elements form the telecommunication network. The network element may also receive communications from client devices connected to the telecommunication network and provide services to such client devices.

Foundation models (FMs) or language models (LMs) such as Large Language Models (LLMs) are computational models used for language generation and other natural language processing, such as text classification. Some LLMs may obtain these abilities by learning the statistical relationship between language tokens through intensive training procedures. With the rapid growth of model size, transformer-based LLMs have shown results in domains such as, for example, instruction following, coding assistance, and creative writing. Among these tasks, unlocking the rationality of LLMs to solve complex reasoning tasks remains a major challenge. Recent works have attempted to tackle this challenge through Supervised Fine-Tuning (SFT). By mixing crafted new reasoning data samples with original datasets, LLMs learn the underlying distributions of these samples and attempt to mimic the logic they have learned to solve unseen reasoning tasks. Although there is a performance gain, this method heavily relies on extensive training and requires extra data preparation.

Large language models (LLMs) are neural network models that learn the semantics and syntax of language by encoding words or subwords into vector representations. These models are trained on extensive datasets and are widely used in various artificial intelligence (AI) applications, including text generation, sentiment analysis, and generic question-answering (QA) systems. LLMs enable these systems to understand and generate responses to a broad range of queries, making them integral to applications like virtual assistants and chatbots.

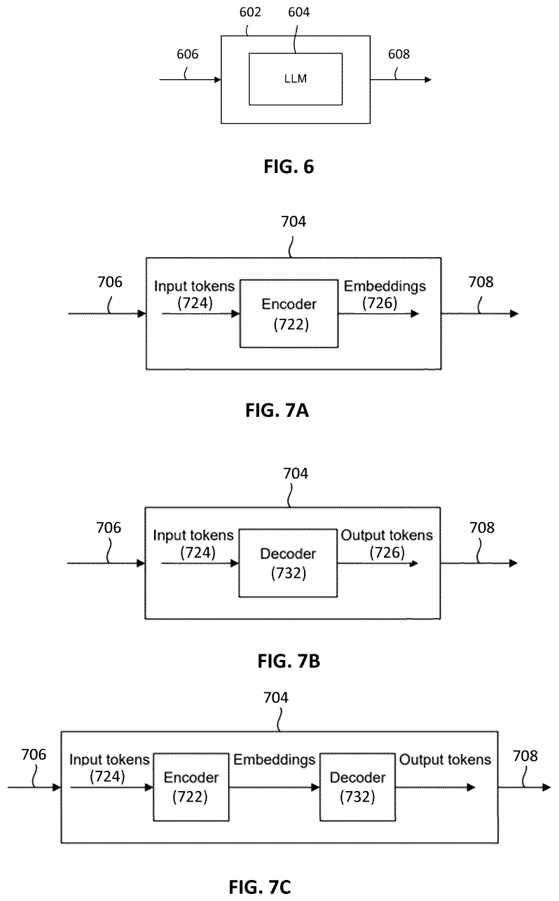

As shown in FIG. 6, the AI engine 602 comprises a FM such as an LLM 604 (which is used as an example in the following description) for processing input 606 (also called “prompt”; for example, natural language input in the form of text, image, voice, and/or the like), recognizing and interpreting the input 606 for generating the output 608 in suitable forms (for example, in form of text, image, audio, video, and/or the like) as the response to the prompt 606. As those skilled in the art will appreciate, foundation models such as LLMs are neural network models that learn the semantics and syntax of language by encoding (sub)words into vector representations.

More specifically, a FM such as an LLM is a computational model that may rely on a large number of computing parameters to perform general purpose text generation and other language tasks such as text classification. LLMs may obtain these abilities by learning the statistical relationship between language tokens through intensive training procedures. A training procedure of an LLM is a procedure during which an LLM learns the statistical relationship between language tokens, usually through auto-regressive learning on some corpus, e.g., predicting the next token given the previous tokens. During this procedure, the ground truth of the tokens to be predicted is known and the errors between the prediction and the ground truth may be iteratively minimized via back-propagation.

Examples of LLMs include ChatGPT (a generative artificial intelligence chatbot developed by OpenAI of San Francisco, California, USA), GPT-4 (Generative Pre-trained Transformer 4, which is a multimodal large language model created by OpenAI of San Francisco, California, USA), LLaMA (a family of autoregressive large language models released by Meta AI of Astor Place, New York City, New York, USA), and PaLM2 (a transformer-based large language model developed by Google AI of Mountain View, California, USA), which have proven to achieve state-of-the-art (SOTA) performance in various natural language processing (NLP) tasks.

FIGS. 7A to 7C are schematic diagrams showing different types of LLM 704. These figures are simplified diagrams for showing the different types of LLM 704 only, and those skilled in the art will understand that the LLM 704 may also comprise other functional modules that are not shown in these figures.

FIG. 7A shows an encoder-based LLM 704 comprising an encoder 722 which processes the input tokens 724 (which are the units (for example, words or characters partitioned from the prompt 706) and generates embeddings 726 (which are then used to generate the output 708). As those skilled in the art understand, embeddings are high-dimensional vectors encoding semantic contexts and relationships of data tokens.

Most popular LLMs 704 are decoder-based (or “decoder-only”) models. As shown in FIG. 7B, the LLM 704 may be an LLM comprising a decoder 732 which processes the input tokens 724 and generates output tokens 736 (which are then used to generate the output 708). More specifically, the decoder-only LLM 704 learns to produce a distribution for the next token in a sequence given past context as input.

As shown in FIG. 7C, the LLM 704 may be an encoder-decoder-based LLM comprising an encoder 722 which processes the input tokens 724 and generates embeddings 726, and a decoder 732 which generates output tokens 736 based on the embeddings 726 (which are then used to generate the output 708).

Through the descriptions of the preceding embodiments, the teachings of the present disclosure may be implemented by using hardware only or by using a combination of software and hardware. Software or other computer executable instructions for implementing one or more embodiments, or one or more portions thereof, may be stored on any suitable computer readable storage medium. The computer readable storage medium may be a tangible or in transitory/non-transitory medium such as optical (e.g., CD, DVD, Blu-Ray, etc.), magnetic, hard disk, volatile or non-volatile, solid state, or any other type of storage medium known in the art.

Additional features and advantages of the present disclosure will be appreciated by those skilled in the art.

The structure, features, accessories, and alternatives of specific embodiments described herein and shown in the Figures are intended to apply generally to all of the teachings of the present disclosure, including to all of the embodiments described and illustrated herein, insofar as they are compatible. In other words, the structure, features, accessories, and alternatives of a specific embodiment are not intended to be limited to only that specific embodiment unless so indicated.

Moreover, the previous detailed description is provided to enable any person skilled in the art to make or use one or more embodiments according to the present disclosure. Various modifications to those embodiments will be readily apparent to those skilled in the art, and the generic principles defined herein may be applied to other embodiments without departing from the spirit or scope of the teachings provided herein. Thus, the present methods, systems, and or devices are not intended to be limited to the embodiments disclosed herein. The scope of the claims should not be limited by these embodiments, but should be given the broadest interpretation consistent with the description as a whole. Reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims.

Furthermore, nothing herein is intended as an admission of prior art or of common general knowledge. Furthermore, citation or identification of any document in this application is not an admission that such document is available as prior art, or that any reference forms a part of the common general knowledge in the art. Moreover, nothing disclosed herein is intended to be dedicated to the public regardless of whether such disclosure is explicitly recited in the claims.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

1. A method at a computing device for selecting an evaluation dataset from a training dataset, comprising:
a) embedding samples from the training dataset into a semantic space;
b) clustering the embedded samples into a plurality of clusters;
c) adding a portion of each cluster to the evaluation dataset;
d) finding boundary samples from the embedded samples;
e) adding the boundary samples to the evaluation dataset;
f) running a Large Language Model (LLM) on each sample of the evaluation dataset using a set of prompts;
g) recording a performance matrix, the performance matrix comprising a vector for each sample of the evaluation dataset, wherein the vector for a given sample represents outputs of the LLM for the given sample across each prompt of the set of prompts;
h) identifying, based on the performance matrix, redundant samples from the evaluation dataset; and
i) replacing at least a portion of the redundant samples with new samples from the training dataset.

2. The method of claim 1, wherein the set of prompts is generated by a prompt optimization technique.

3. The method of claim 2, further comprising repeating steps f), g), h), and i) with a new set of prompts from the prompt optimization technique.

4. The method of claim 1, further comprising removing, from the training dataset, samples added to the evaluation dataset.

5. The method of claim 1, further comprising:
receiving an input indicating a size N of the evaluation dataset;
wherein step c) adds αN samples to the evaluation dataset, where α is a proportion of samples to be obtained from semantic clustering.

6. The method of claim 5, wherein step e) adds (1−α)N boundary samples to the evaluation dataset.

7. The method of claim 5, wherein step c) adds a number of samples from each cluster which is proportional to a size of each cluster.

8. The method of claim 1, wherein step d) comprises finding a first set of boundary samples in the semantic space.

9. The method of claim 8, further comprising finding, for each boundary sample in the first set of boundary samples, a most distant sample in the semantic space.

10. The method of claim 1, wherein the outputs of the LLM for the given sample is a vector of logit values.

11. The method of claim 1, wherein two samples are considered redundant if their respective vectors from the performance matrix have a correlation coefficient greater than a threshold.

12. The method of claim 11, wherein the threshold is 0.9.

13. The method of claim 1, wherein step h) comprises creating clusters of redundant samples.

14. The method of claim 13, wherein step i) comprises removing a portion β of each cluster of redundant samples.

15. The method of claim 14, wherein step i) comprises replacing removed samples, wherein a replacement sample for a given removed sample is a most distant sample of the given removed sample in the training dataset.

16. The method of claim 15, wherein the most distant sample is identified using a Hierarchical Navigable Small World (HNSW) algorithm.

17. A computing device for selecting an evaluation dataset from a training dataset comprising:
a processor;
memory;
wherein the computing device is configured to:
a) embed samples from the training dataset into a semantic space;
b) cluster the embedded samples into a plurality of clusters;
c) add a portion of each cluster to the evaluation dataset;
d) find boundary samples from the embedded samples;
e) add the boundary samples to the evaluation dataset
f) run a Large Language Model (LLM) on each sample of the evaluation dataset using a set of prompts;
g) record a performance matrix, the performance matrix comprising a vector for each sample of the evaluation dataset, wherein the vector for a given sample represents outputs of the LLM for the given sample across each prompt of the set of prompts;
h) identify, based on the performance matrix, redundant samples from the evaluation dataset; and
i) replacing at least a portion of the redundant samples with new samples from the training dataset.

18. The computing device of claim 17, wherein the set of prompts is generated by a prompt optimization technique.

19. The computing device of claim 17, wherein the outputs of the LLM for the given sample is a vector of logit values.

20. A non-transitory computer readable medium having stored thereon executable code for execution by a processor of a computing device, the executable code comprising instructions for:
a) embedding samples from the training dataset into a semantic space;
b) clustering the embedded samples into a plurality of clusters;
c) adding a portion of each cluster to the evaluation dataset;
d) finding boundary samples from the embedded samples;
e) adding the boundary samples to the evaluation dataset
f) running a Large Language Model (LLM) on each sample of the evaluation dataset using a set of prompts;
g) recording a performance matrix, the performance matrix comprising a vector for each sample of the evaluation dataset, wherein the vector for a given sample represents outputs of the LLM for the given sample across each prompt of the set of prompts;
h) identifying, based on the performance matrix, redundant samples from the evaluation dataset; and
i) replacing at least a portion of the redundant samples with new samples from the training dataset.
